(19) United States
(12) Patent Application Publication
(10) Pub. No.: US 2026/0051700 A1
(43) Pub. Date: Feb. 19, 2026

(54) ELECTRICAL CONNECTOR ASSEMBLY

(71) Applicant: Aptiv Technologies AG, Schaffhausen (CH)

(72) Inventors: Uvaraj GANESAN, Tamil Nadu (IN); Romain SAVINA, Saint Martin de (FR); Sylvain LOAS, Le Gault Saint Denis (FR); Laurent DELESCLUSE, Saint Piat (FR)

(21) Appl. No.: 19/298,659

(22) Filed: Aug. 13, 2025

(30) Foreign Application Priority Data
Aug. 14, 2024 (EP) 24194590.6

(51) Int. Cl. H01R 13/629

(52) U.S. Cl. CPC H01R 13/62944; H01R 13/62955

(57) ABSTRACT

An electrical connector assembly includes a connector housing and a mate assist lever pivotably connected thereto. The mate assist lever is movable from a preliminary mating position to a fully mated position to facilitate connector mating. A cover is mounted to the connector housing. A connector position assurance (CPA) element is movably arranged on the mate assist lever between first and second positions. The CPA element features a latching member that engages a locking portion on the mate assist lever in the first position. Upon mounting the cover to the connector housing, the latching member is released from the locking portion, thereby allowing the CPA element to move to the second position. In this second position, the CPA element assures correct positioning of the mate assist lever and prevents its disconnection from the connector housing, thereby enhancing the reliability and security of the connector assembly during use.

### CROSS-REFERENCE TO RELATED APPLICATION

This application claims the benefit of and priority to European Application No. 24194590.6 filed with the European Patent Office on Aug. 14, 2024, the contents of which are incorporated by reference herein.

### TECHNICAL FIELD

The present disclosure generally relates to an electrical connector assembly. More particularly, it relates to an electrical connector assembly including connector modules of a set of connector modules that is matingly connected to a corresponding electrical counter connector assembly and disconnected by operation of a lever of the electrical connector assembly.

### BACKGROUND

A common “lever-type” electrical connection includes an assembly of a first connector assembly or housing and a second connector assembly or header. To mate the connector assemblies together, the connection has an actuating or assist lever mounted for pivoting on the first connector assembly, with pivoting of the lever causing the first and second connector assemblies to shift between unmated and fully mated configurations. Usually, the actuating lever and the second connector assembly typically have a cam groove and a cam follower arrangement for drawing the second connector assembly into mating condition with the first connector assembly in response to pivoting of the lever. Such connectors are commonly used in the automotive industry but require complex mechanics.

A typical example for such lever-type electrical connections is to provide a generally U-shaped lever structure having a pair of relatively thin-walled lever sidebars that are disposed on opposite sides of the housing connector. The lever sidebars may have cam grooves for engaging cam follower projections or posts on opposite sides of the header assembly. These types of lever connectors are often used where relatively large forces are required to mate and unmate a pair of connector assemblies. For instance, frictional forces encountered during connecting and disconnecting the connector assemblies may make the process difficult to perform by hand. In some cases, relatively large electrical connectors with high pin counts, such as connectors with 90 or more pin contacts, require at least about 300 N to mate or unmate the connectors. Further, automotive industry standards require a maximum of 75 N of user input force to perform this mating and un-mating of the connectors.

A problem with these lever-type electrical connection assemblies is that the lever may disconnect from the housing and pivot towards the opening direction when subjected to vibrations which are typical in an automobile in use. It may cause a safety hazard when the first connector assembly and the second counter connector assembly are disconnected.

The object of this disclosure is to overcome the disadvantages of the prior art connectors, and particularly to provide an electrical connector that is safe in use, may be mated and unmated with little effort, provides a reliable design, may be easily mounted, and has only a small packaging footprint.

### SUMMARY

The above-mentioned objectives may be realized by an electrical connector assembly including a connector housing, a mate assist lever pivotably connectable to the connector housing being movable from a preliminary mating position to a fully mated position to facilitate the mating process of the connector housing, a cover, and a connector position assurance (CPA) element arranged movable on the mate assist lever between a first and a second position. The CPA element includes a latching member that engages a locking portion on the mate assist lever in the first position and which latching member is configured to be released from the locking portion upon mounting of the cover to the connector housing, such that the CPA element may be brought to the second position where the CPA element assures the correct positioning and prevents disconnection of the lever with respect to the housing. Thus, the CPA element may be moved to the second position only when the cover is placed at the correct location within the electrical connector assembly. This is a control mechanism provided to ensure that the different elements of the electrical connector assembly are assembled in the correct way. Accordingly, if at any stage the cover is not in the proper position, or the lever is not in the fully mated position, the CPA element cannot be brought to the second position indicating to an assembly operator that the connector and counter-connector are not appropriately mated. Subsequently, an accidental disconnection, for example due to vibrations of the car in which the electrical connector assembly is mounted, may be avoided when the CPA element is moved to the second position.

The lever may be connected to the housing by means of a primary locking latch engaging primary locking means on the connector housing to reversibly latch the lever onto the connector housing in the fully closed position. Of course, other reversible connection means may alternatively be contemplated, such as buckles, clamps, clips, pins, snap fasteners, or the like. The important feature is that it should be easily reversible, as the lever is pivoted during assembly and later unlatched and opened to be pivoted again during the mating process.

The CPA element may include a blocking element that is configured to allow unlatching of the primary locking latch when the CPA element is in the first position on the lever and to block unlatching of the primary locking latch when the CPA element is in the second position. In one embodiment, the blocking element has a platelike shape that is inserted in a channel behind the primary locking latch, thereby substantially filling the whole space of the channel. When the blocking element is inserted into the channel, it acts as a wedge. It is a reliable and sturdy way of blocking which is not prone to breaking, even under harsh conditions such as a vibrating environment. The blocking element may be integral to the rest of the CPA element.

The primary locking latch may be pivotably arranged at its center axis such that, the primary locking latch is allowed to pivot to disengage from the primary locking means when the blocking element is in the first position and the primary locking latch is blocked and cannot pivot to disengage from the primary locking means when the blocking element is in the second position. In the first position, the blocking element is located above the center axis around which the primary locking latch pivots. This way, there is enough space provided under the axis to allow the primary locking latch to tilt out of engagement with the primary locking means. In the second position, the blocking element slides in the channel past the center axis to occupy the space next to the primary locking latch. Because the space to tilt the latch is filled, it is not possible to pivot the primary locking latch out of engagement. The center axis is located at a center region of the primary locking latch and cuts the primary locking latch into two sections. The first section has a first length, and the second section has a second length, which may be different from the first length. The only requirement is that the first length and the second length need to be long enough to function as lever. The length of the lever may be chosen according to the force wished to activate the lever mechanism, and thereby to latch and unlatch the primary locking latch.

To release the latching member of the CPA from the locking portion on the lever, and to allow moving the CPA element from the first position to the second position, the cover may include an activation tab which engages the latching member of the CPA element to release the latching member from the locking portion of the lever, such that the CPA element is allowed to move from the first to the second position. The activation tab may be a protruding element which engages the latching member only if it is in the correct position. As already mentioned, there is immediate feedback as to whether the cover is adequately placed when assembling the cover. The protruding element then deflects the latching member, such that it is brought out of engagement with the locking portion of the lever. The CPA element may then slide to the second position, where it blocks the primary locking latch in its engagement position with the primary locking means on the connector housing.

In detail, the latching member may further include a retention feature provided on a flexible arm. The retention feature is in abutment with the locking portion of the lever in the first position. With this arrangement, the CPA element cannot move to the second position unless the retention feature is brought out of abutment with the locking portion. Because the retention feature is located at a distance from the point of attachment of the flexible arm, for example, at the end of the flexible arm, the retention feature may be brought out of abutment by flexing the flexible arm.

The CPA may also include a loss prevention latch which cooperates with a loss prevention stop feature on the lever to retain the CPA in the first position. The loss prevention latch is configured to prevent the movement of the CPA in a direction opposite to a direction of movement from the first to the second position. The loss prevention latch is designed to ensure that the CPA element remains on the lever once it has been connected to it while mounting the connector assembly. When the CPA element is first connected to the lever during mounting, it will snap into the first position. From here, the CPA element cannot leave the lever because the loss prevention latch blocks the CPA element from sliding out. Other types of mechanisms may also be envisaged to keep the CPA within the lever, such as clips, clastic elements in a recess, obliquely toothed sides, if the direction opposite the direction of mounting the CPA element on the lever is blocked.

To ensure that the CPA element does not slide out, the loss prevention latch may include a stop surface provided on a flexible leg. The deflection direction of the flexible leg is perpendicular to the deflection direction of the flexible arm. By choosing a different deflection direction of the flexible arm with respect to the flexible leg, it is ensured that the CPA element will remain firmly attached to the lever even when the cover is mounted on the connector housing, because the deflection of the flexible arm has no influence on the deflection of the flexible leg. The combination of a flexible leg with a stop surface is easy to produce in a monolithic CPA element, produced for example by molding or 3D printing. It combines simple deflection for an effortless mounting of the CPA element with a sufficient spring-back force to bias the stop surface into contact with the loss prevention stop feature.

The flexible leg is essentially U-shaped to allow the deflection of the flexible leg during mounting of the CPA element. With this arrangement, the pivoting point of the flexible leg of the loss prevention latch is inserted into the guiding slots of the lever before the flexible leg, which minimizes insertion issues. The stop surface of flexible leg subsequently snaps into abutment with the loss prevention stop feature.

The CPA element is preferably assembled to the lever on the opposing side of the pivoting axis when the lever is connected to the connector housing at a pivoting axis. The force needed to hold the lever is smallest when the force is applied as distant as possible from the pivoting axis. As mentioned before, it may not be possible to foresee the CPA element on the opposing side of the pivoting axis. In that case, it is still advantageous to position the CPA element as far away as possible from the pivoting axis to benefit from the lever effect.

In some examples, the lever is essentially U-shaped and includes a crossbar and two sidebars extending from the ends of the crossbar. The pivoting axis is then located at the ends of the side bars, and the CPA element is advantageously connected to the crossbar of the lever. As previously mentioned, it is possible to connect the CPA element at another location, such as the side bars. A U-shaped lever has the advantage of an ergonomic handling of the mating forces and of an equal distribution of the mating forces on both sides of the connector assembly.

In one embodiment, the following steps may be used to assemble the electrical connector to the preliminary mating condition:

The CPA element is assembled with the lever, in a predetermined, first assembled position. To retain the CPA element in the first assembled position, the CPA element may include retention features cooperating with corresponding features on the lever. The lever is pivotably connected to the connector housing at a pivoting axis, before or after the CPA has been connected to the lever. In any case, the CPA element is advantageously placed on the opposing side of the pivoting axis. When the lever is rotated to a fully closed position, in which the lever is reversibly latched to the connector housing, the cover may be engaged on the connector housing. The cover may include an activation tab configured to bring at least part of the retention features of the CPA element out of the retention position such that the CPA element is allowed to slide from the first assembled position to the second locking position in which the lever may be locked in the latching position onto the connector housing.

The connector housing is reversibly latched to the lever by means of a primary locking latch engaging locking means on the connector housing. Generally, the cover is engaged on the connector housing after the cables and the connector modules have been mounted to the connector housing. Once the cover is engaged, the lever is unlatched and brought to an open, preliminary mating condition in which the lever is secured to the cover. In the preliminary mating condition, the connector assembly is ready to be mated with a counter connector assembly.

Once assembled, the steps required to mate the electrical connector assembly with a counter connector assembly are as follows: First, an electrical connector assembly is provided in the preliminary mating position. This connector assembly already houses the connector modules and the cables, and the cover is placed on the connector assembly to protect the connector modules and the cables. Next, the connector assembly is initially mated with the counter connector assembly such that when the lever is rotated to a fully closed position in the following step, the connector assembly meshes with the counter connector assembly and both connector assemblies are drawn towards each other. At the end of the rotation the lever is latched to the connector housing in the fully closed position. The CPA element is moved from the first position to the second position where the CPA element locks the lever onto the connector housing to secure the latching of the lever and thereby prevent disconnecting of the two connector assemblies. The lever may be locked onto the connector housing by means of a blocking tab of the CPA element, which is moved from the first assembled position where the blocking tab allows the primary blocking latch to disengage from the locking means to the second locking position, where the blocking tab blocks unlatching of the latch.

The connector assembly may be unmated from the counter connector assembly by reversing the order of the steps to mate them. First, the CPA element is moved from the second locking position to the first position, in which the primary locking latch is allowed to tilt and disengage. The end of the primary locking latch is subsequently pushed to bring the primary locking latch out of engagement with the primary locking means on the connector housing, and the lever is pivoted to the preliminary mating position. The counter connector assembly is disconnected from the connector assembly by pivoting the lever.

### BRIEF DESCRIPTION OF THE DRAWINGS

In the following, preferred embodiments of the disclosure are disclosed by reference to the accompanying figure, in which shows:

FIG. 1 is an isometric view of an electrical connector assembly according to some embodiments.

FIG. 2 is an exploded view of the components of an electrical connector assembly according to some embodiments.

FIG. 3 is an isometric view of the lever of an electrical connector assembly according to some embodiments.

FIG. 4 is an isometric view of a detail of the lever showing the primary locking latch and the locking portions of the lever of an electrical connector assembly according to some embodiments.

FIG. 5 is an isometric view of a cut through the locking latch of the lever showing the pivoting axis of the locking latch of an electrical connector assembly according to some embodiments.

FIG. 6 is an isometric view of the CPA element showing the blocking element of the CPA element of an electrical connector assembly according to some embodiments.

FIG. 7 is an isometric view of the CPA element prior to mounting on the lever, and a portion of the lever of an electrical connector assembly according to some embodiments.

FIG. 8 is an isometric view of the CPA element mounted on the lever and a portion of the lever, showing a cut through the retention feature of the latching member of the CPA element of an electrical connector assembly according to some embodiments.

FIG. 9 is an isometric view of the CPA element mounted on the lever and a portion of the lever, showing another cut-through perpendicular to the one shown in FIG. 8 and exposing the loss prevention latch of the CPA element and the loss prevention stop feature on the lever of an electrical connector assembly according to some embodiments.

FIG. 10 is an isometric view of the CPA element mounted on the lever, a portion of the lever and a portion of the connector housing, showing yet another cut through the primary locking latch of the lever, the connector housing and the CP-element with the blocking element in the first position of an electrical connector assembly according to some embodiments.

FIG. 11 is an isometric view of the CPA element mounted on the level, like the view shown in FIG. 10, and showing the position of the mounted cover of an electrical connector assembly according to some embodiments.

FIGS. 12A to 12C show cross-section views of the CPA element, a detail of the connector housing, a detail of the lever and a detail of cover in the second position in shown with cuts at two different levels during a sequence in which the CPA moves from the first position to the second position in an electrical connector assembly according to some embodiments.

FIG. 13 is a side view of the connector assembly showing the mounting sequence of the cover on the connector housing of an electrical connector assembly according to some embodiments.

FIG. 14 is a side view of the connector assembly, wherein the cover is mounted on the connector housing and the lever is in a fully mated position of an electrical connector assembly according to some embodiments.

FIG. 15 is an isometric view of the mounted connector assembly as delivered for detailed cross-sectional view of the electrical connector of FIG. 6 in a working position showing a second gear wheel element of an electrical connector assembly according to some embodiments.

FIG. 16 is a side view of the electrical connector of FIG. 1 in the pre-assembly position of an electrical connector assembly according to some embodiments.

FIG. 17 is a cross-sectional view showing the gear wheels of the mating mechanism and the lever attachment in the pre-assembly position of an electrical connector assembly according to some embodiments.

### DETAILED DESCRIPTION

In the following, preferred embodiments of the present disclosure are described in detail with respect to the figures.

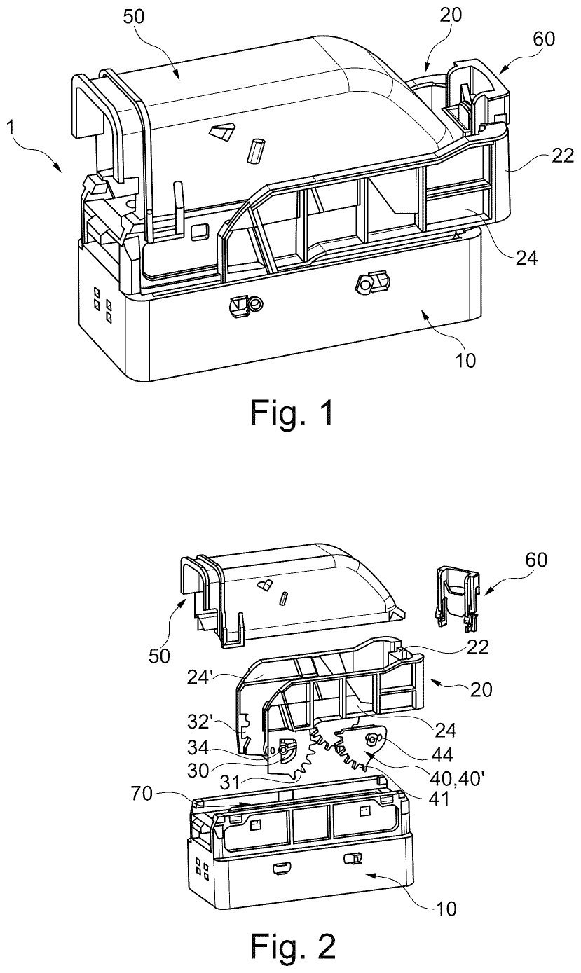

FIG. 1 shows an isometric view of a first preferred embodiment of an electrical connector assembly.

The electrical connector assembly 1 includes a connector housing 10, a mate assist lever 20 pivotably connectable to the connector housing 10, a cover 50, a CPA element 60 which may be moved between a first position and a second position. The lever may be moved from a preliminary mating position (not shown in FIG. 1) to a fully mated position as shown in FIG. 1 to facilitate the mating process of the connector housing 10 with the electrical counter connector assembly. When the CPA element 60 is in the first position, as shown in FIG. 1, the lever 20, which is reversibly latched to the connector housing 10, may be unlatched by disengaging the primary locking latch 21 from the primary locking means 11 on the connector housing 10, as may be seen in FIG. 11.

The exploded view of FIG. 2 shows two sets of gear wheels 30, 30′, 40, 40′, which shows the means to urge the counter connector assembly into mating position with the connector assembly in more detail. The connector housing 10 is divided into three slots: a main slot and two side slots in which the gear wheels 30, 30′, 40, 40′ are housed. The lever 20 has a crossbar 22 and two sidebars 24, 24′ extending from the ends of the crossbar 22. The lever 20 is pivotably connected to the housing 10 through pins 34, 34′ on the first set of gear wheels 30, 30′, which are accommodated in elongated holes in the side slots. The second set of gear wheels 40, 40′ is connected to the housing through pins 44, 44′, which are equally accommodated in holes in the side slots.

The housing 10 includes one or more slots for holding the respective number of connector modules 70. The connector modules 70 are inserted from the top into the slots of the connector housing 10 and preferably latch therein by means of elastic latches within the slots and/or at the connector modules 70.

The cover 50 closes the upper end of the electrical connector 1 and protects the cables (not shown) and connector modules 70 from mechanical damage. Preferably the cover 50 is hooked to the connector housing 10 by a positive fit at the front end and by connection means 51 at the rear end (shown in FIG. 13).

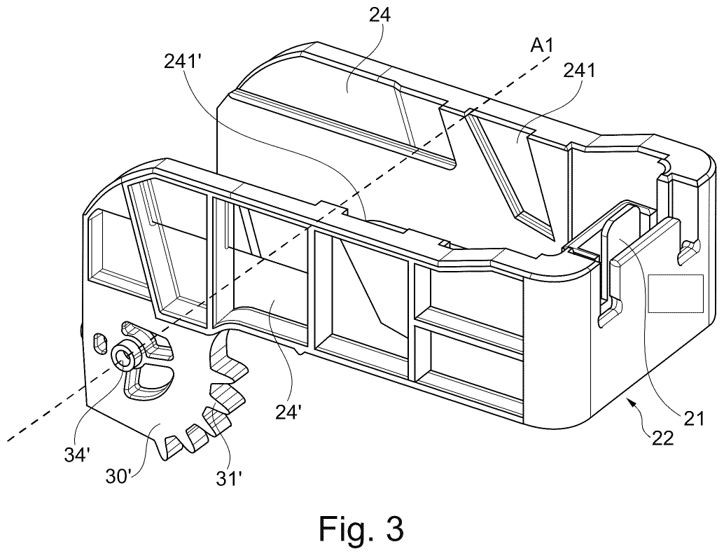

As visible in detail in FIG. 3, the lever 20 is generally U-shaped and includes a generally horizontal crossbar 22 and two generally vertical sidebars 24, 24′. The sidebars 24, 24′ extend generally perpendicularly from the ends of the crossbar 22.

The lever 20 further includes the pair of first gear wheel elements 30, 30′ which are integrally formed with the lower end of the respective side bars 24, 24′. The first gear wheel elements 30, 30′, and thus the overall lever 20, are rotatably mounted to the connector housing 10 around axis A1 defined by first rotation pins 34, 34′. The first rotation pins 34, 34′ extend from the first gear wheels elements 30, 30′ horizontally to the outside.

The first gear wheel elements 30, 30′, each includes a first set of first gear teeth 31, 31′ for meshing with second sets of first gear teeth 41, 41′ of second gear wheel elements 40, 40′. In addition, each first gear wheel element 30, 30′ includes a first set of second gear teeth 32, 32′ (not visible in FIG. 3) for meshing with a teethed protrusion 82 of an electrical counter connector assembly 80 (see FIG. 17). Thus, the first gear wheel elements 30, 30′ includes a “double gear configuration” by integrating two different gear wheels into one. In the embodiment shown the first set of first gear teeth 31, 31′ adopts a section of the first gear wheel element 30, 30′ and generally points to the top or interior of the connector housing 10. The first set of second gear teeth 32, 32′ adopts another section of the first gear wheel element 30, 30′ and generally points to the bottom or exterior of the connector housing 10. The first sets of second gear teeth 32, 32′, include only one full tooth and two half teeth, however, the number of teeth of the first sets of first and second gear teeth 31, 31′, 32, 32′ may vary as appropriate.

Similar considerations apply for the pair of second gear wheel elements 40, 40′ (see FIG. 2). The second gear wheel elements 40, 40′ are rotatable around a pair of second rotation pins 44, 44′ extending to the outside from the second gear wheel elements 40, 40′. The second gear wheel elements 40, 40′ each include a second set of first gear teeth 41, 41′ for meshing with first sets of first gear teeth 31, 31′ of first gear wheel elements 30, 30′ and a second set of second gear teeth 42, 42′ for meshing with a teethed protrusion 82′ of the counter connector assembly 80. Thus, the second gear wheel elements 40, 40′ also include a “double gear configuration” by integrating two different gear wheels into one. In the embodiment shown the second set of first gear teeth 41, 41′ adopt a section of the second gear wheel element 40, 40′ and generally point to the top or interior of the connector housing 10. The second sets of second gear teeth 42, 42′ adopt another section of the second gear wheel element 40, 40′ and generally points to the bottom or exterior of the connector housing 10. The second set of second gear teeth 42, 42′ includes only one full tooth and two half teeth, however, the number of teeth of the second sets of first and second gear teeth 41, 41′, 42, 42′ may vary as appropriate.

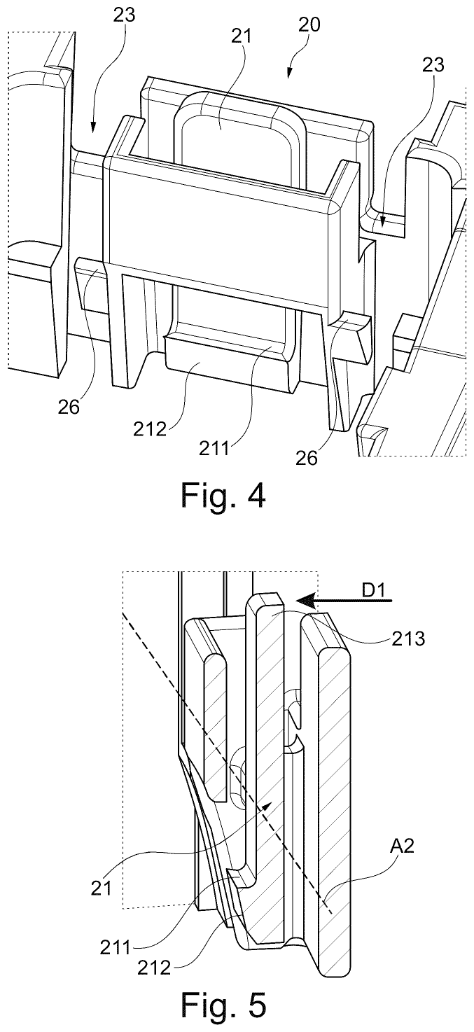

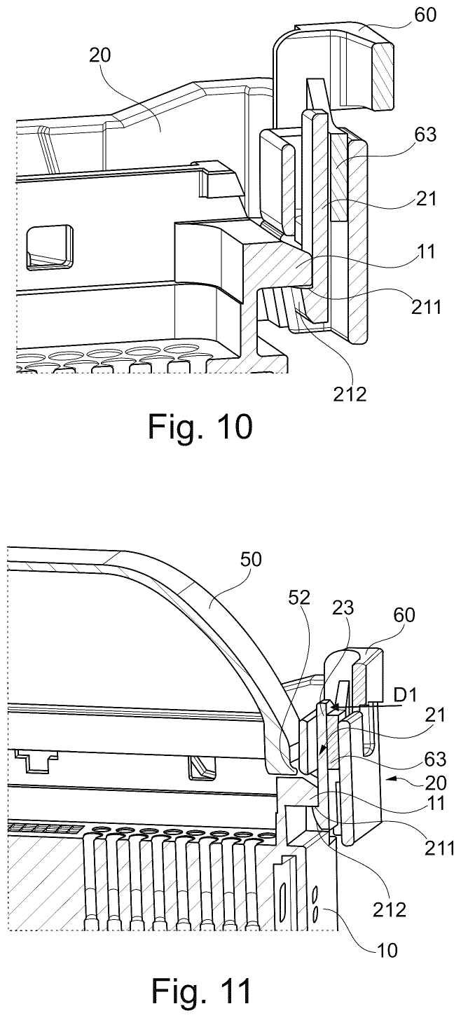

In FIGS. 3, 4 and 5, the primary locking latch 21 is shown on crossbar 22 of lever 20. Of course, such a primary locking latch 21 may also be placed at another location instead of the crossbar, such as the sidebars 24, 24′ of the lever. FIG. 4 shows more detail of the primary locking latch 21 and its surroundings. The primary locking latch 21 includes an engagement hook 211 for engagement with primary locking means 11 on the connector housing 10 (see FIG. 10). The primary locking latch 21 further includes an abutment surface 212 which deflects the primary locking latch 21 when the lever 20 is pivoted to the fully mated position, such that the engagement hook 211 at the end of the locking latch 21 engages the primary locking means with an clastic spring force. The clastic spring force is provided by the attachment of the primary locking latch 21 to the lever at a central axis A2 such that the primary locking latch 21 may pivot around the central axis A2 and elastically spring back into the central default position of the locking latch 21. The central attachment of the primary locking latch further allows an end 213 of the primary locking latch to protrude from the crossbar. The primary locking latch 21 may then be manually pivoted against the clastic spring force by pushing the latch in the direction D1 to disengage the engagement hook 211 from the primary locking means on the connector housing 10.

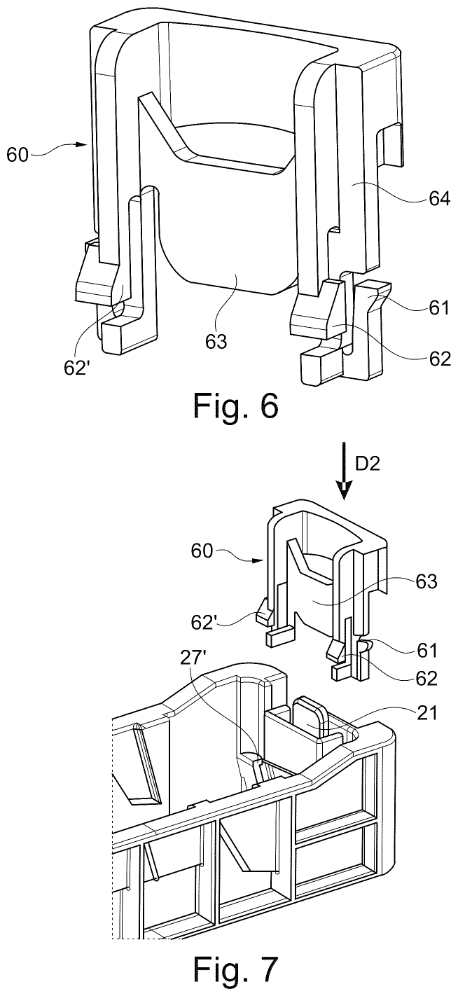

FIG. 6 shows one embodiment of the CPA element 60 in detail. In the illustrated embodiment, the CPA element 60 has two separate retention features 61, 62 configured to retain the CPA element in a first assembled position within the crossbar 22 of the lever 20. The CPA element 60 further includes a blocking tab 63. When the CPA element is in the first assembled position on lever 20, the blocking tab is located above the axis A2. Therefore, it allows pivoting and unlatching of the primary locking latch 21. When the CPA element is in a second locking position on lever 20, the blocking tab is located below the axis A2 and blocks unlatching of the primary locking latch 21 from the connector housing 10. The CPA element 60 may include a guiding protrusion 64, which cooperates with a guiding slot 23 on the crossbar 22 of the lever 20, to guide the CPA element 60 on the lever 20. To assemble the CPA element with the lever to the first assembled position, it is moved in the direction D2, as may be seen in FIG. 7. The guiding protrusions 64 are inserted on the guiding slot 23 of the lever and the CPA element is moved until it is blocked by the retention feature abutting the locking portion 27 on the lever 20.

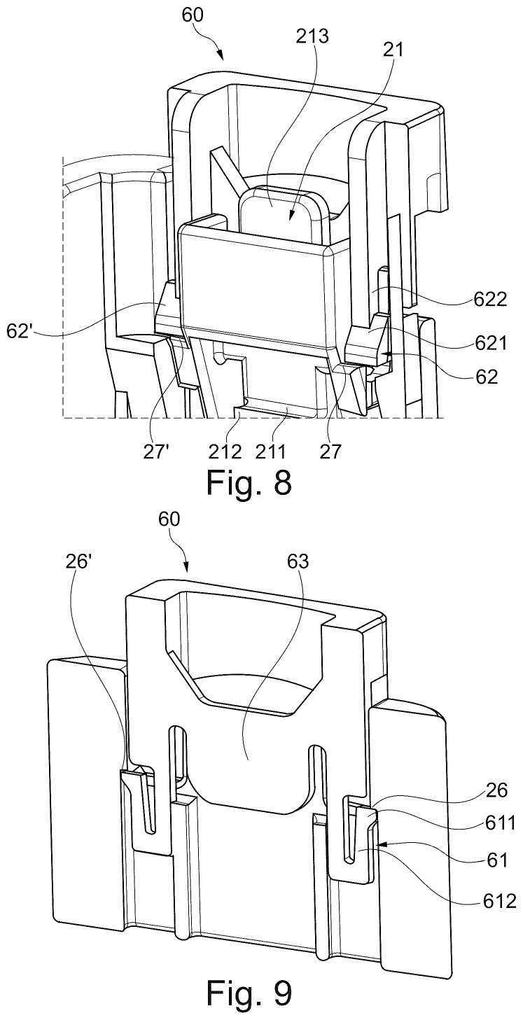

FIGS. 8 and 9 show details of the retention features 61, 62 holding the CPA element 60 in the first position. As shown in FIG. 8, the retention features include a latch member 62 mounted on a flexible arm 622. The latch member 62 includes a retention feature 621 cooperating with locking portion 27 on the lever to retain the CPA element in a second sliding direction opposite the first sliding direction.

FIG. 9 shows a cut through the loss prevention latch 61. It is mounted on an essentially U-shaped flexible leg 612 and includes a stop surface 611 on the flexible leg 612 which cooperates with a loss prevention stop feature 26 on the lever to retain the CPA element from falling of the lever by holding it in a first sliding direction.

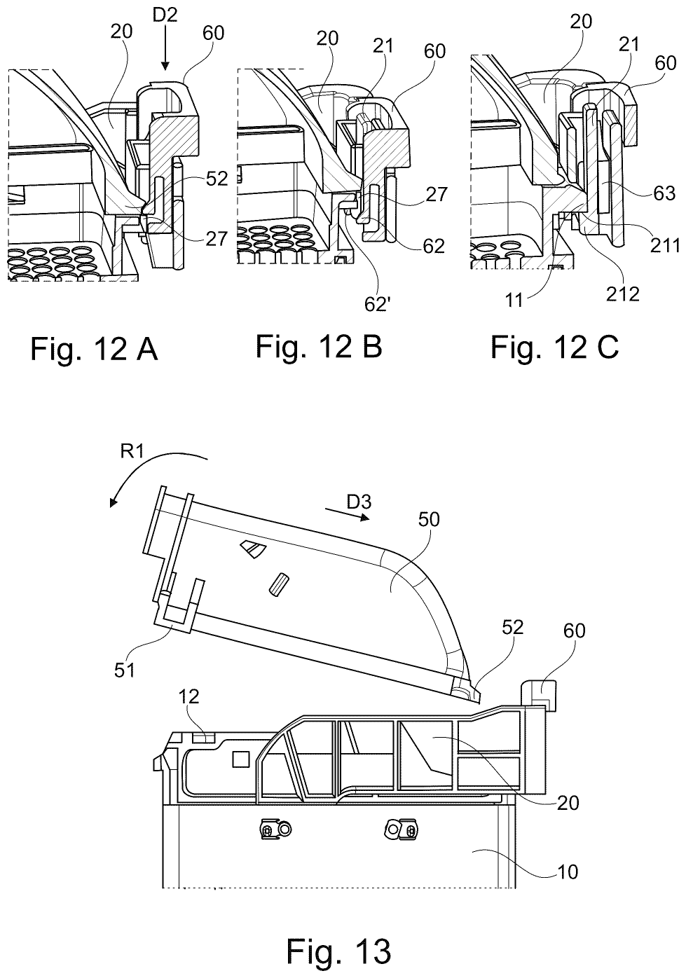

In FIGS. 10 and 11 show cross-sections through the latching mechanism of the lever 20 on the connector housing 10. In both figures, the CPA element is in the first position, where the primary locking latch 21 may be tilted around its rotation axis to bring the engagement hook 211 out of engagement with the primary locking means 11. As illustrated in FIGS. 10 and 11, the blocking element 63 of the CPA element 60 ends before the axis of the latch 21, i.e., before the connection points of the latch 21 to the lever 20. The abutment surface 212 pushes the latch 21 to overcome the primary locking means 11 and elastically hook on the primary locking means 11 with the engagement hook 211 when the lever 20 is tilted from the preliminary mating position to the fully mated position. FIG. 11 indicates the direction D1 to unlatch lever 20 from the connector housing 10. The end 23 of the primary locking latch 20 is pushed to bring the engagement hook out of engagement with the primary locking means. FIG. 11 further shows the detail of the cover 50 connected to the housing next to the CPA element 60. This cut does not show how the activation tab 52 pushes the latch member 62 out of engagement. This may be seen in FIGS. 12A and 12B.

The embodiment shown in FIGS. 12A to 12C further illustrates how the CPA element 60 is moved from the first position to the second position, in which the CPA element 60 assures the correct positioning of the lever and the cover and prevent disconnection of the lever with respect to the connector housing 10. In FIG. 12C the blocking tab fills the space between the primary locking latch 21 and the crossbar of the lever 20 such that the primary locking latch cannot be pivoted anymore. This way, the latching member 21 securely engages locking portion 27 even under rough conditions, such as in automotive applications.

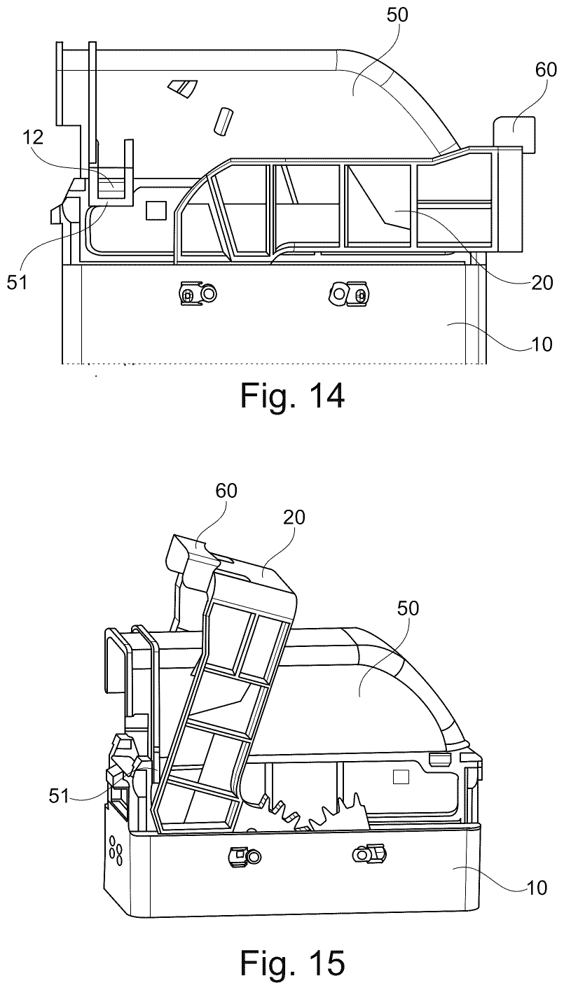

Connector assembly 1 is typically delivered to a wiring harness maker in a condition where the cover 50 is not yet connected to connector housing 10. The wiring harness maker will connect the connector modules 70 to cables and subsequently add the cover to protect the cables and the connector modules. FIG. 13 shows the mounting sequence of cover 50 on the connector housing 10 once the harness maker has connected all the cables. In a first step the activation tab 52 of the cover 50 is connected to the connector housing 10 in a movement in the indicated direction D3. In a second step, cover 50 is pivoted in the rotation direction R1 until the connection means 51 on the cover 50 are brought into connecting engagement with counter connection means 12 on the connector housing 10 to connect the cover 50 to the connector housing 10 (see FIG. 14). When cover 50 is connected to the connector housing 10, the activation tab 52 pushes the latching member 62 of the CPA element 60 to disengage from the locking portion 27, thereby allowing to move the CPA element 60 from the first assembled position to the second locking position in which the position of the lever 20 is locked and secured onto the connector housing 10, because the primary locking latch 21 of the lever is blocked from disengaging the primary locking means 11 on the connector housing 10.

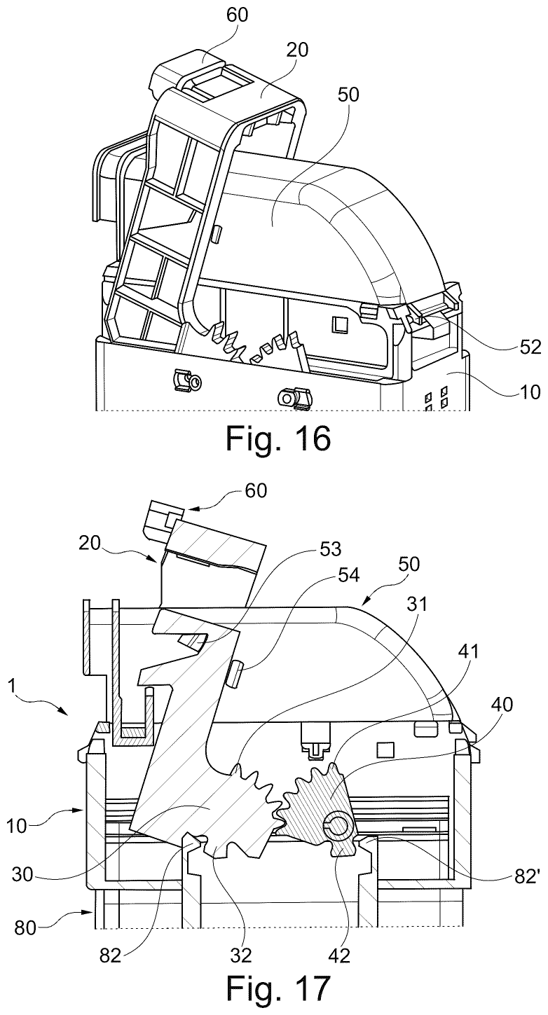

, The lever 20 is brought to the preliminary mating position once the cover 50 is mounted. This is how the connector assembly is delivered to mate with the counter connector assembly 80. FIGS. 15, 16, and 17 show the lever in the preliminary mating position. The mating mechanism and the lever holding arrangement may best be seen in FIG. 17. To secure the lever in the preliminary mating position, the cover has a lever abutment 53 cooperating with a slot 241 on the lever 20 and a lever holding protrusion 54, to temporarily fix the lever in the preliminary mating position.

It is also apparent from FIG. 17 that, by rotating the lever 20, the first pair of gear wheel elements 30, 30′ rotate, and drive the second pair of gear wheel elements 40, 40′, when the sets of first gear teeth 31, 41 of first and second pair of gear wheels elements 30, 30′, 40, 40′ respectively are in meshed engagement. To connect the connector assembly 1 with the counter connector assembly 80, the sets of second gear teeth 32, 42 of each gear wheel element 30, 30′, 40, 40′ respectively mesh with teethed protrusions 82, 82′ of a counter connector assembly 80.

While the invention has been described with reference to an exemplary embodiment(s), it will be understood by those skilled in the art that various changes may be made, and equivalents may be substituted for elements thereof without departing from the scope of the invention. In addition, many modifications may be made to configure a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc., are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

### LIST OF REFERENCE SIGNS

1 electrical connector assembly
10 connector housing
11 primary locking means
20 lever
21 primary locking latch
211 engagement hook
212 abutment surface
213 end of primary locking latch
22 crossbar
23 guiding slot
24, 24′ side bars
241, 241′ slots
26 loss prevention stop feature
27 locking portion
30, 30′ first gear wheel elements
31 first set of first gear teeth
32 first set of second gear teeth
34, 34′ first rotation pins
40, 40′ second gear wheel elements
41 second set of first gear teeth
42 second set of second gear teeth
44, 44′ second rotation pins
50 cover
51 connection means
52 activation tab
53 lever abutment
54 lever holding protrusion
55 cover latch
60 connector position assurance (CPA)-element
61, 62 retention features
61 loss prevention latch
611 stop surface
612 flexible leg
62 latching member
621 retention feature
622 flexible arm
63 blocking tab
64 guiding protrusion
70 connector module
80 counter connector assembly
82, 82′ teethed protrusions
A1 pivoting axis of the lever on the connector housing
A2 axis of rotation of the primary locking latch on the lever
D1 first, unlatching direction for unlatching the primary locking latch
D2 second, assembly direction for assembling the CPA element with the lever
D3 third, mounting direction to connect the first end of the cover on the connector housing
R1 first rotation direction to connect the cover to the connector housing

1. An electrical connector assembly, comprising:
a connector housing;
a mate assist lever pivotably connected to the connector housing and being movable from a preliminary mating position to a fully mated position to facilitate a mating process of the connector housing;
a cover; and
a connector position assurance (CPA) element arranged movable on the mate assist lever between a first and a second position, wherein the CPA element includes a latching member that engages a locking portion on the mate assist lever in the first position and which latching member is configured to be released from the locking portion upon mounting of the cover to the connector housing, such that the CPA element may be brought to the second position where the CPA element assures correct positioning and prevents disconnection of the lever with respect to the connector housing.

2. The connector assembly according to claim 1, wherein the lever includes a primary locking latch engaging primary locking means on the connector housing to reversibly latch the lever onto the connector housing in the fully mated position.

3. Connector assembly according to claim 2, wherein the CPA element includes a blocking element configured to allow unlatching of the primary locking latch when the CPA element is in the first position on the lever and to block unlatching of the primary locking latch when the CPA element is in the second position.

4. Connector assembly according to claim 3, wherein the primary locking latch is arranged pivotably at its center axis such that, when the blocking element is in the first position, the primary locking latch is allowed to pivot to disengage from the primary locking means and, when the blocking element is in the second position, the primary locking latch is blocked and cannot pivot to disengage from the primary locking means.

5. The connector assembly according to claim 1, wherein the cover includes an activation tab configured to engage the latching member of the CPA element to release the latching member from the locking portion of the lever, such that the CPA element is allowed to move from the first to the second position.

6. The connector assembly according to claim 5, wherein the latching member includes a retention feature provided on a flexible arm, the retention feature being in abutment with the locking portion of the lever in the first position.

7. The connector assembly according to claim 6, wherein the CPA further includes a loss prevention latch cooperating with a loss prevention stop feature on the lever to retain the CPA in the first position.

8. The connector assembly according to claim 7, wherein the loss prevention latch is configured to prevent movement of the CPA in a direction opposite to a direction of movement from the first to the second position.

9. Connector assembly according to claim 7, wherein the loss prevention latch includes a stop surface provided on a flexible leg and a deflection direction of the flexible leg is perpendicular to the deflection direction of the flexible arm.

10. Connector assembly according to claim 9, wherein the flexible leg is essentially U-shaped.

11. The connector assembly according to claim 1, wherein the lever is connected to the connector housing at a pivoting axis, and the CPA element is assembled to the lever on an opposing side of the pivoting axis.

12. Connector assembly according to claim 11, wherein the lever is essentially U-shaped and includes a crossbar and two sidebars extending from ends of the crossbar, the pivoting axis being located at the ends of the sidebars and the CPA element being connected to the crossbar of the lever.

13. A method of assembly of an electrical connector assembly having a connector housing, a mate assist lever pivotably connectable to the connector housing and being movable from a preliminary mating position to a fully mated position to facilitate a mating process of the connector housing, a cover, and a connector position assurance (CPA) element arranged movable on the mate assist lever between a first and a second position, wherein the CPA element includes a latching member that engages a locking portion on the mate assist lever in the first position and which latching member is configured to be released from the locking portion upon mounting of the cover to the connector housing, such that the CPA element may be brought to the second position where the CPA element assures correct positioning and prevents disconnection of the lever with respect to the connector housing, the assembly method comprising:
providing the electrical connector assembly connector housing with a mate assist lever;
rotating the lever to a fully closed position in which the lever is latched to the connector housing;
mounting the cover on the connector housing; and thereafter
moving the CPA element from the first position to the second position where the CPA element locks the lever onto the connector housing.
